(19) United States
(12) Patent Application Publication
(10) Pub. No.: US 2006/0255508 A1
(43) Pub. Date: Nov. 16, 2006

(54) Process for manufacture of sanitary ware acrylic plates, of synthetic granite, using cast system with or without abs reinforcement

(76) Inventor: Luis Carlos Maradini, Sao Paulo (BR)

Correspondence Address: WILLIAM COLLARD;COLLARD & ROE, P.C., 1077 NORTHERN BOULEVARD, ROSLYN, NY, 11576, US

(21) Appl. No.: 10/531,059

(22) PCT Filed: Jan. 14, 2005
(86) PCT No.: PCT/IB05/50174

§ 371 Date: Apr. 12, 2005

(51) Int. Cl. C08J 5/00

(52) U.S. Cl. 264/331.18

(57) ABSTRACT

“Process for Manufacture of Sanitary Ware Acrylic Plates, of Synthetic Granite, Using Cast System, with or without ABS Reinforcement”, presenting an inedited process for obtaining sanitary ware-synthetic granite type acrylic, providing for the execution of two polymerization stages, the stage called first polymerization (D), is defined by a step called first mould preparation (D1); a step called mould filling (D2), where the mould is filled with the first formulation; a step called polymerization (D3) where the moulds are placed inside an autoclave, this operation obeying a thermal curve where the initial temperature is 50° C., and after one hour this temperature is increased to 120° C. and maintained constant until the end of the period with a total time of five hours, and after four hours begins the cooling step (D4) of the moulds and the plates polymerized inside it, passing to a mould cooling step (D4), plate demoulding step (D5); plate grinding step (D6) where the plates are grinded; a step called particle selection (D7). The stage called second polymerization (E) presents a first step called second mould preparation (E1); a step called mould filling (E2); a step called degassing (E3); a step called polymerization (E4), where they are filled with the second formulation and placed inside the autoclave, whose thermal curve presents initial temperature of 50° C., increased to 80° C. and maintained for one hour, after this period the temperature is increased to a level of 120° C. and maintained until the end of the period of four hours, after which begins the step of second cooling of the moulds (E5), where the moulds return to the autoclave, with a new and final polymerization; a step of final demoulding of the plates (E6).

This invention patent request is a “PROCESS FOR MANUFACTURE OF SANITARY WARE ACRYLIC PLATES, OF SYNTHETIC GRANITE, USING CAST SYSTEM, WITH OR WITHOUT ABS REINFORCEMENT”, where the requester presents an inedited concept of obtaining process for the acrylic plates, regularly applied as raw material for manufacture of products such as bathtubs, toilet covers and sinks, acrylic chairs, among other products with the features of thin or thick layers, needing deep molding.

The process for obtaining sanitary ware -synthetic granite type plates claimed herein also has the advantage of allowing placing a reinforcement element, of ABS type, during the plate assembly process itself, together with the PVC, for this situation the plates do not have any changes in their formulation.

The introduction of ABS reinforcements, places in the sanitary ware-synthetic granite plates, allows products such as hydro-massage bathtubs, acrylic chairs among others, being thermoformed with the product, eliminating the need for applying resins, such as fiberglass and others, allowing gains in terms of productivity, reflected in the reduction of operation costs and also in the work health area, since the health damages produced by handling such products are of public knowledge.

Still in the scope of using ABS reinforcement, this process provides more strength to the final product after molding, not needing the application of any type of resin, it can also be considered that the same adds value in terms of final finish of the product, since the adhesion of the product (ABS) to the granite acrylic plates is perfect, conforming a single body, when for the process before the introduction of the reinforcement in posterior process there are adhesion problems and consequent premature depreciation of the product.

The sanitary ware-synthetic granite (S.W.G.S.) product, resulting for the process claimed herein, in general, presents the same technical and physical characteristics of the already known processes, while adding another advantage allowing a reduction in the necessary thickness for molding, since this one presents better physical characteristic at large depths.

Thus, the basic characteristic of the sanitary ware-synthetic granite (S.W.G.S) plates resulting from the process claimed herein is the act that these allow molding depths up to 1300 mm.

This is a consistent advantage when compared to the result obtained for the sanitary ware-synthetic granite (S.W.G.S) plates produced by processes already known to the state of the art technique, reaching maximum 1050 mm, also the Casting system provides the product with more solvent resistance and strength over already known processes such as Continuous Cast and Extruded.

Finally, the requester presents also a last advantage, on the financial point of view, where the process claimed herein demands an initial investment around US$7,000,000.00, which is at least four times lower than the necessary investment for the execution of the manufacture process of sanitary ware-synthetic granite (S.W.G.S) plates know of the state of the art technique, this investment never is under US$45,000,000.00.

Having considerably reduced the financial cost of the investment, the manufacturer of sanitary ware-synthetic granite (S.W.G.S) plates using the process claimed herein, will have larger maneuver margin for the composition of the final price of the product, not only due to productivity gains, but also due to the fact that the amortization of the investment in the cost composition will be greatly reduced.

In order to allow these advantages, the requester claims, with this invention patent request, as inedited process for the production of sanitary ware-synthetic granite (S.W.G.S) plates using the Casting system, which becomes a third production process for this means, and is still not used nor Patented in the world, since it is different from everything that is know by the state of the art technique due to the fact that its execution requires the use of equipment never used before for this means.

Also, the process claimed herein presents totally differentiated formulations, we may affirm that it is an inedited process of the Casting System for granite plates, this fact provides the global market with a new option for the production of sanitary ware-synthetic granite (S.W.G.S) plates, with advantages in economic terms, product quality improvement and also in term of work health.

During the last decades, we had a lot of progress in the development of new products in polymeric material, needing large molding depth, such as hydro-massage tubs, toilet covers, sink, acrylic chairs and other products, the manufacture using sanitary ware-synthetic granite (S.W.G.S) plates.

For the manufacture of sanitary ware-synthetic granite (S.W.G.S) plates, the state of the art technique knows basically two manufacture processes.

The first known manufacture process of sanitary ware-synthetic granite (S.W.G.S) plates is called Continuous Cast system, developed by Du Pont company and currently belonging to LUCITE.

The second known manufacture process of sanitary ware-synthetic granite (S.W.G.S) plates is called Extrusion system, developed by the ARISTECH company.

For both cases, the process and the formulations are different, also using distinct equipment for each process.

In general, the process for obtaining

Normal-Acrylic Plates, called Cast system, know by the state of the art technique, may be understood from the following description:

The raw material, Methyl Metacrylate—MMA, is received in bulk liquid, in Iso tank or drum, stored in a tank or reservoir, specially prepared for this application.

The production process of acrylic plates begins by pumping MMA into the reactor where it is heated up to 80° C., causing its pre-polymerization.

During this stage, is added a catalyst, demoulding and solar filter, ready for pigmenting, in case of colored plate, or will remain in the original crystal color.

During the next stage, the glass moulds, after passing by the washing process, are assembled with the placement of a PVC cord used to close the glass blades, composing the mould.

Then the pre-polymerized product is placed into the glass moulds, the PVC cord maintains the liquid inside it and provides the desired thickness of the plate, varying according to the cord diameter.

After the glass moulds are duly filled, with pre-polymerized product, they are placed in an autoclave type equipment, hot water tank, or even in an oven, and then are polymerized to the acrylic plates by the “Casting” system.

Each equipment used in the polymerization of the product demands a different process such as: formulation, thermal curve, pressure and also different polymerization time.

After this process, the moulds with the already polymerized plates are removed from the equipment used for the polymerization and are cooled and then demoulded, passing at last by a quality inspection process for posterior packing.

The necessary formulation for obtaining Acrylic plates, in the basic form called crystal, and colored, may be such as described in the table:

TABLE
Standard Formulation for Obtaining Acrylic Plates.

| | |
|---|---|
| Raw material | Methyl Metacrylate (M.M.A.) |
| Catalyst | 64 vessel - Dupont |
| Demoulding | Aerosol - OT 100% - Cytec/Tinuvin: P - Ciba |
| Cord | Cord: PVC |
| Ford cup 4° viscosity | 40/100 sec. |
| Initial water temperature | Depending on equipment |
| Final water temperature | Depending on equipment |
| Pigmentation | As per desired color |
| Thermal curve (° C.) | Depending on equipment |

The process described above is in general a description of the known state of the art process for obtaining an acrylic plate, by Cast system, being just a reference, and also used as subsidy for better understanding the process for manufacture of sanitary ware-synthetic granite (S.W.G.S) plates by Cast system, claimed herein.

As presented and known in terms of process for obtaining sanitary ware-synthetic granite (S.W.G.S) plates, the requester presents, in inedited format, a third process for obtaining the mentioned process, bringing advantages on the technical, operational and financial point of view not observed until the moment, the mentioned process maybe object of a privileged request, since it merits the requirements defined in the Industrial Property Law in force.

To complement this description for better understanding the characteristics of this invention patent request, this description is attached with a set of drawings with process flow and heating curves for polymerization of acrylic-synthetic granite plates, by the cast system, representing as example, but not limiting, a realization format for the process claimed herein, where:

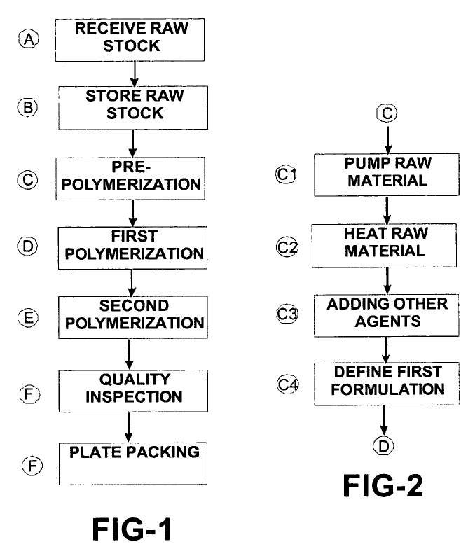

FIG. 1 presents a flow diagram of the main stages of the manufacture process of acrylic sanitary ware plates claimed herein,

FIG. 2 is a flow diagram of the steps consisting the pre-polymerization stage of the manufacture process of acrylic sanitary ware plates claimed herein,

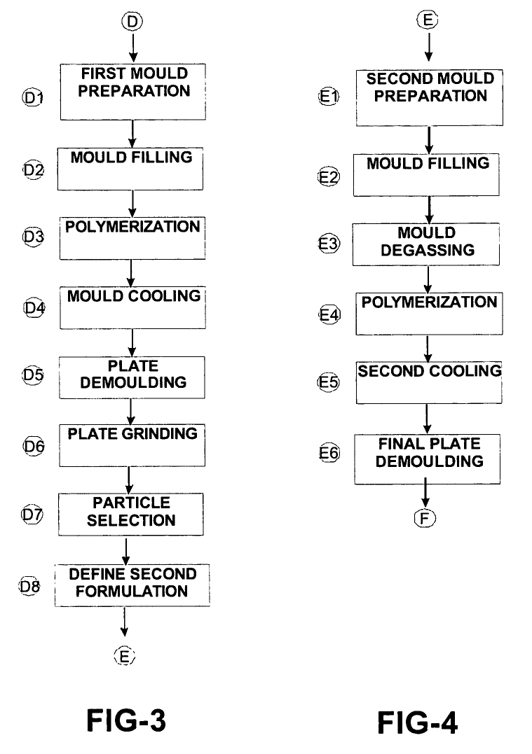

FIG. 3 is a flow diagram of the steps consisting the stage called first polymerization of the manufacture process of acrylic sanitary ware plates claimed herein,

FIG. 4 is a flow diagram of the steps consisting the stage called second polymerization of the manufacture process of acrylic sanitary ware plates claimed herein,

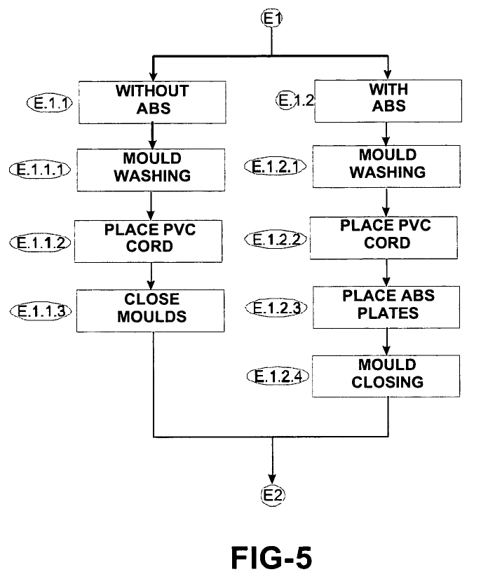

FIG. 5 is a flow diagram of the sub-steps consisting two possible realization formats for the step called second preparation of the mould provided in the stage called second polymerization of the manufacture process of acrylic sanitary ware plates claimed herein,

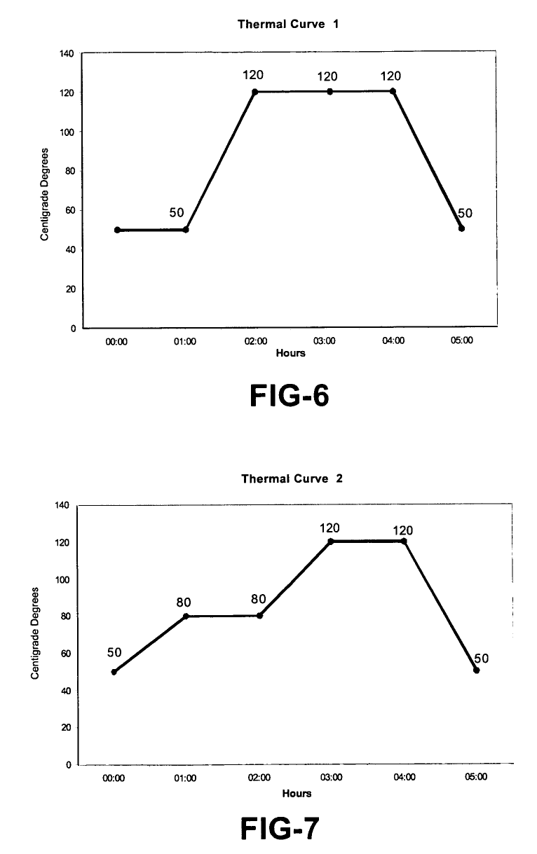

FIG. 6 is a thermal heating and cooling curve format representation of the first formulation, necessary for the stage called pre-polymerization of the manufacture process of acrylic sanitary ware plates claimed herein,

FIG. 7 is a thermal heating and cooling curve format representation of the second formulation, necessary for the stage called second polymerization of the manufacture process of acrylic sanitary ware plates claimed herein.

Relative to the flows and charts illustrating this invention patent request relative to a new “PROCESS FOR MANUFACTURE OF SANITARY WARE ACRYLIC PLATES, OF SYNTHETIC GRANITE, USING CAST SYSTEM, WITH OR WITHOUT ABS REINFORCEMENT”, where in FIG. 1, the requester illustrates the first level logic of the process claimed herein, based upon the stages called receiving raw material (A), store raw material (B), pre-polymerization (C), first polymerization (D), second polymerization (E), quality inspection (F) and plate packing (G), which once executed, allow obtaining sanitary ware-synthetic granite (S.W.G.S) plates.

The first stage, called receiving raw material (A), provides receiving the Methyl Metacrylate—MMA product, in liquid state, is received in bulk, in Iso tank or drum.

The second stage, called raw material storage (B), defines the storage of the Methyl Metacrylate—MMA product in a tank/reservoir, specially prepared for this application.

A third stage, called pre-polymerization (C), is represented by the step flow, in FIG. 2, with the purpose of obtaining a first formulation necessary for the process claimed herein.

This stage consists of a first step, called pumping raw material (C1), where the Methyl Metacrylate—MMA product is pumped in to a reactor type equipment.

Once pumped, begins the second step, called raw material heating (C2), where the Methyl Metacrylate—MMA product is heated to 85° C., causing its pre-polymerization.

To complement the pre-polymerization, also a third step is provided, called adding other agents (C3), introducing agents such as catalysts, demoulding and other fundamental Additives for obtaining the synthetic granite plate.

A last step of this stage, called definition of the first formulation (C4), may be represented as per table 1.

TABLE 1
First Formulation

| | |
|---|---|
| Raw material | Methyl Metacrylate (M.M.A.) |
| Catalysts | Catalyst for the polymerization process. |
| | Catalyst to assist obtaining chemical resistance |
| | to solvents. |
| Additives | Allows the so called Cross Linking and also |
| | increases mouldability and elasticity. |
| Demoulding | Avoids the adhesion of the plates to the mould. |
| PVC cord | Maintains plate thickness. |
| Ford cup 4° viscosity | 100/110 sec. |
| Initial water temperature | 50.0 +/− 1.0° C. |
| Final water temperature | 120.0 +/− 1.0° C. |

Once finished the pre-polymerization stage (C), begins the fourth stage, called first polymerization (D), which is represented by the step flow, in FIG. 3, with the purpose of obtaining a first polymerization necessary for the process claimed herein.

The first step is called first preparation of the mould (D1), where the moulds, after passing by the washing system, are assembled placing a PVC cord with the function of assuring the thickness of the acrylic plate, used to close the glass blades consisting the mould for forming the plate.

The second step is called mould filling (D2), where the mould previously prepared in the first step, is filled with the first formulation, obtained in the step of definition of the first formulation (C4) of the pre-polymerization stage (C).

In the subsequent step, called polymerization process (D3), the moulds, duly filled with the first formulation, are placed in autoclave type equipment, which are indispensable for obtaining the synthetic granite by the cast system, the thermal curve varies with time, pressure and temperature.

The pressure indicated for the first polymerization stage (D) is about 6.0 kgf/cm², according to a thermal curve, duly represented by the chart of temperature variation with time, in FIG. 6, showing an initial temperature of 50° C., and after one hour this increases to 120° C., and is maintained constant until the end of the period with total time of five hours, after four hours begins the cooling step (D4) of the moulds and of the plates polymerized inside them, during this step the moulds with the acrylic plates obtained from the first polymerization are removed from the autoclave type equipment, for appropriate cooling.

Once duly cooled, the obtained plates pass by the step of demoulding the plates (D5), where these are removed from the moulds, also cooled.

With the plates resulting from the first polymerization, begins a sixth step, called plate grinding (D6), where already in the color previously defined for the granite, the plates are grinded, by specific equipment for this application (hydrogeny) obtaining acrylic particles, pre-determined for the synthetic granite aspect.

Finally, to complement the first polymerization stage (D), there is the last step, called particle selection (D7), where the particles obtained from the former step, are separated, according to previously defined quality criteria.

One last step, definition of the second formulation (D8), is necessary for the execution of the stage called second polymerization (E), which may be represented by table 2.

TABLE 2
Second Formulation

| | |
|---|---|
| Raw material | Methyl Metacrylate (M.M.A.) |
| Catalysts | A catalyst for the polymerization process. |
| | A catalyst that assists obtaining chemical |
| | resistance to solvents. |
| Additives | Allows the so called Cross Linking and also |
| | increases mouldability and elasticity. |
| Demoulding | Avoids the adhesion of the plates to the mould. |
| PVC cord | Maintains plate thickness. |
| ABS plate | Used to reinforce acrylic plates |
| Ford cup 4° viscosity | 40/110 sec. |
| Initial water temperature | 50.0 +/− 1.0° C. |
| Final water temperature | 120.0 +/− 1.0° C. |

Once defined the second formulation, by the step of definition of the second formulation (D8), begins the stage called second polymerization (E), duly represented in FIG. 4, presenting a first step called second mould preparation (E1), which may present two distinct and possible procedures, which can be seen in FIG. 5.

A first form of realization of the step called second mould preparation (E1) is called without ABS (E.1.1), not considering the use of ABS plates, defining the sub-steps for mould washing (E.1.1.1), placement of the PVC cord (E.1.1.2) and mould closing (E.1.1.3).

A second form of realization of the step called second mould preparation (E1) is called with ABS (E.1.2) and considers using ABS plates, defining the sub-steps of mould washing (E.1.2.1), placing PVC cord (E.1.2.2), placing ABS plates (E.1.2.3) and mould closing (E.1.2.4), the use of ABS plates is justified for obtaining a better structured final product, stronger and with differentiated finish characteristic.

Once finished the step of the second mould preparation (E1), begins a second step called mould filling (E2), promoting the mix of the particles previously obtained in the step called particle selection (D7), still in the first polymerization stage (D), with the liquid (vehicle) previously polymerized, also with the formulations for granite.

The step called mould filling (E2) is under a low temperature system with appropriate pressure were the liquid and the particles do not suffer hardening or quick polymerization, which demands a pre-determined low temperature.

Once duly filled the moulds, begins a step called degassing (E3), which removes all the air bubbles, which requires a vacuum system and also a vibrating system, for the particles to fill all the moulds.

The next step is called polymerization (E4), where the moulds duly filled with the second formulation, are places inside autoclave type equipment, which are indispensable for obtaining synthetic granite by cast system, with the thermal curve varying with time, pressure and temperature.

The polymerization step (E4) follows a thermal curve, duly represented in the chart of temperature variation with time, presenting an initial temperature of 50° C., which is increased to 80° C., maintained during one hour, and then the temperature is increased to a 120° C. level, and maintained at the same until the end of the four hour period, after which begins the process of cooling the same, this described condition may be seem best in the thermal curve chart, presented in FIG. 7, remembering that for this process to result in as appropriate product, the same requires two polymerization in autoclave.

The pressure indicated for stage of the second polymerization process (E) is about 4.0 kgf/cm².

After the polymerization step (E4), begins the second cooling step (E5) where after removing the plates from the autoclave, they are cooled again, and then following the final step of demoulding the plates (E6), from where the obtained plates are taken to a quality inspection stage (F), were the final standard checking is conducted (quality control), and then begins the final stage of the process claimed herein, defined as the stage of packing the plates (G).

From the described and illustrated it is a process that fits the standards regulating the Invention Patent, considering the Industrial Property Law, meriting from the described, and as a consequence, the respective privilege.

1. “Process for Manufacture of Sanitary Ware Acrylic Plates, of Synthetic Granite, Using Cast System, with OR without ABS Reinforcement”, characterized for presenting a first level logic, with a first stage called receiving raw material (A); a second stage called storage of raw material (B), a third stage called pre-polymerization (C), a fourth stage called polymerization (D), a fifth stage called second polymerization (E), a sixth stage called quality inspection (F) and a seventh stage called plate packing (G).

2. “Process for Manufacture of Sanitary Ware Acrylic Plates, of Synthetic Granite, Using Cast System, with or without ABS Reinforcement”, in accordance to claim 1, characterized by the stage called pre-polymerization (C), being defined by a first step, called pumping raw material (C1), where the Methyl Metacrylate—MMA product is pumped inside a reactor type equipment, a step called raw material heating (C2), where the Methyl Metacrylate—MMA product is heated up to 85° C., a step called addition of other agents (C3).

3. “Process for Manufacture of Sanitary Ware Acrylic Plates, of Synthetic Granite, Using Cast System, with or without ABS Reinforcement”, in accordance to claim 2, characterized by the definition of a first formulation where the raw material is Methyl Metacrylate (M.M.A.), a catalyst for the polymerization process, a catalyst for obtaining chemical resistance to solvents, a demoulding agent, a PVC cord, with Ford cup 4° viscosity= 100/110 sec.; initial water temperature=50.0+/−1.0° C.; final water temperature=120.0+/−1.0° C.

4. “Process for Manufacture of Sanitary Ware Acrylic Plates, of Synthetic Granite, Using Cast System, with or without ABS Reinforcement”, in accordance to claim 1, characterized by the stage called first polymerization (D), with a step called first preparation of the mould (D1); one step called mould filling (D2), where the mould is filled with the first formulation, a step called polymerization (D3) where the moulds are placed inside the autoclave, a step of mould cooling (D4); plate demoulding step (D5); plate grinding step (D6), where the plates are grinded; a step called particle selection (D7).

5. “Process for Manufacture of sanitary Ware Acrylic Plates, of Synthetic Granite, Using Cast System, with or without ABS Reinforcement”, in accordance to claim 4, characterized by the definition of a second formulation where the raw material is Methyl Metacrylate (M.M.A.); a catalyst for the polymerization process; an auxiliary catalyst for obtaining chemical resistance to solvents; an additive allowing the so called Cross Linking; an additive that increases mouldability and elasticity; a demoulding agent, a PVC cord, an ABS plate; Ford cup 4° viscosity= 40/110 sec.; initial water temperature=50.0+/−1.0° C.; final water temperature=120.0+/−1.0° C.

6. “Process for Manufacture of Sanitary Ware Acrylic Plates, of Synthetic Granite, Using Cast System, with or without ABS Reinforcement”, in accordance to claim 4, characterized by the polymerization step (D3) respecting a thermal curve, with initial temperature of 50° C., and after one hour this temperature increases to 120° C. and is maintained constant until de end of the period with a total time of five hours, and after four hours begins the cooling step of the mould (D4) and of the polymerized plates inside it.

7. “Process for Manufacture of Sanitary Ware Acrylic Plates, of Synthetic Granite, Using Cast System, with or without ABS Reinforcement”, in accordance to claim 1, characterized by the stage called second polymerization (E) presenting a first step called second preparation of the moulds (E1), a step called mould filling (E2); where under low temperature (pre-determined) and pressure the moulds are filled with the second formulation; step called degassing (E3), with the removal of all the air bubbles, a step called polymerization (E4), where the moulds return to the autoclave, with a new and final polymerization, a second cooling step (E5); a final plate demoulding step (E6).

8. “Process for Manufacture of Sanitary Ware Acrylic Plates, of Synthetic Granite, Using Cast System, with or without ABS Reinforcement”, in accordance to claim 7, characterized by a first form of conducting the step called second mould preparation (E1), called without ABS (E.1.1), not considering the use of ABS plates, with the sub-steps of mould washing (E.1.1.1), placing PVC cord (E.1.1.2) and closing the moulds (E.1.1.3).

9. “Process for Manufacture of Sanitary Ware Acrylic Plates, of Synthetic Granite, Using Cast System, with or without ABS Reinforcement”, in accordance to claim 7, characterized by second form of conducting the step called second mould preparation (E1), called with ABS (E.1.2), with the sub-steps of mould washing (E1.2.1), PVC cord placing (E.1.2.2), ABS plate placing (E.1.2.3) and mould closing (E.1.2.4).

10. “Process for Manufacture of Sanitary Ware Acrylic Plates, of Synthetic Granite, Using Cast System, with or without ABS Reinforcement”, in accordance to claim 7, characterized by the polymerization step (E4), whose thermal curve presents an initial temperature of 50° C., increased to 80° C. and maintained for one hour, after this period the temperature is increased to a 120° C. level and maintained until the end of the four hours period, after which begins the process of cooling the same.
